(19) United States
(12) Patent Application Publication
(10) Pub. No.: US 2024/0017613 A1
(43) Pub. Date: Jan. 18, 2024

(54) DISPLAY DEVICE FOR A VEHICLE

(71) Applicant: Continental Automotive Technologies GmbH, Hannover (DE)

(72) Inventors: Konrad Rothenhäusler, Achberg (DE); Christian Scharfenberger, Lindau (DE)

(73) Assignee: Continental Automotive Technologies GmbH, Hannover (DE)

(21) Appl. No.: 18/034,810

(22) PCT Filed: Oct. 22, 2021
(86) PCT No.: PCT/DE2021/200162

§ 371 Date: May 1, 2023

(30) Foreign Application Priority Data
Nov. 2, 2020 (DE) 10 2020 213 770.6

(51) Int. Cl. B60K 35/00; G06F 3/01

(52) U.S. Cl. CPC B60K 35/00; G06F 3/013; B60K 2370/149; B60K 2370/152; B60K 2370/155; B60K 2370/1575; B60K 2370/182; B60K 2370/48; B60K 2370/788; B60K 2370/148

(57) ABSTRACT

A display device for a vehicle, comprising an electro-optical display and a position detection device which is used to determine the position of eyes of a driver of the vehicle, wherein a multiplicity of different items of information are displayed by the electro-optical display device and are perceived by the driver of the vehicle is disclosed. Provision is made for there to be a viewing direction detector for determining the driver's viewing direction, which is used to determine which information of the multiplicity of different items of information are perceived by the driver, and, depending on the perceived information, for the perceived information to be able to be enlarged and/or for additional information relating to the perceived information to be able to be displayed. A method for displaying information on a display device in a vehicle is also disclosed.

### CROSS REFERENCE TO RELATED APPLICATIONS

This U.S. patent application claims the benefit of PCT patent application No. PCT/DE2021/200162, filed Oct. 22, 2021, which claims the benefit of German patent application No. 10 2020 213 770.6, filed Nov. 2, 2020, both of which are hereby incorporated by reference.

### TECHNICAL FIELD

The present disclosure relates to a display device for a vehicle, having an electro-optical display and a position detection device which may be used to determine the position of the eyes of a driver of the vehicle.

### BACKGROUND

Such electro-optical displays, which display a multiplicity of items of information such as operating parameters of the vehicle and other information, are known from the prior art. The position detection device which may be used to determine the position of the eyes of a driver of the vehicle is, for example, used to monitor the state of the driver of the vehicle and, for example, to be able to warn the driver before falling asleep. The multiplicity of items of information may restrict the ability of the driver to grasp the information. The object of the disclosure is therefore to improve the perceptibility of the information displayed on the electro-optical display.

### SUMMARY

As a result of the fact that the information perceived by the driver may be enlarged and/or additional information relating to the perceived information may be displayed by the display device according to the disclosure, depending on the perceived information, and the method according to the disclosure involves determining the driver's viewing direction and determining which information of the various items of information is perceived by the driver and that, depending on the perceived information, the perceived information is enlarged and/or additional information relating to the perceived information is displayed, the information that is primarily of interest to the driver is displayed in a more perceptible manner to the driver. For example, when a glance at the fuel gage is detected, the latter may be enlarged. It is also possible to switch from an analog pointer display to a digital display. However, it is also possible to only enlarge the display and display it, for example, in the middle area of the display device. It is also possible to display additional information relating to the displayed information. For example, when looking at the fuel gage, the fuel gage may be enlarged and the achievable range of the vehicle may be displayed with the current tank content. A distinction may also be made here as to whether the vehicle will continue to be operated at the current speed or ranges for changed speeds may also be additionally indicated. Furthermore, if there is information about the nearest gas station, this information may be displayed. When looking at a speedometer, for example, an indication of the maximum speed allowed for the section of road currently being traveled on may also be displayed and a warning may be output if the maximum speed allowed is exceeded.

As a result of the fact that the information displayed by the display device may be moved and changed in size in such a way that no information is hidden from the driver by a component of the vehicle, the driver may perceive all the essential information without changing his head position and thus is not distracted from driving the vehicle more than necessary. The position of the displayed information may thus be selected in such a way that, for example, the vehicle's steering wheel does not hide any information from the driver.

If the display device has a second electro-optical display and additional information may be displayed on the second electro-optical display, the safety of the vehicle may be increased.

If the second electro-optical display is arranged on an A-pillar of the vehicle, it may be perceived particularly easily without looking away from the road for too long.

If the environment behind the A-pillar of the vehicle may be displayed on the second electro-optical display arranged on an A-pillar of the vehicle, smaller creatures and objects adjacent to the vehicle may also be easily perceived.

If the viewing direction detector is arranged in the A-pillar, B-pillar or in the roof liner of the vehicle, the driver's viewing direction may be easily determined.

If the display device has a voice output unit or is connected to a voice output unit, information may be transmitted to the driver even more safely.

This voice output may be switched on and/or switched off, for example, by a gaze gesture by the driver.

If the range of the fuel level for the current driving style is displayed when a fuel gage is displayed, the driver has more meaningful information than if only the tank content is displayed to him.

If the range of the fuel level for at least one alternative driving style is displayed, the driver may better decide which driving style he chooses.

The information may be perceived particularly well if the display of the information is shifted and changed in size in such a way that no displayed information is hidden from the driver by a component of the vehicle.

### BRIEF DESCRIPTION OF THE DRAWINGS

The disclosure is explained in more detail below with reference to the figures for embodiments, in which:

FIG. 1 shows a view of the interior of a vehicle with an embodiment of a display device according to the disclosure and a driver of the vehicle;

FIG. 2 shows a view of the display on the electro-optical display with a plurality of items of displayed information; and

FIG. 3 shows a view of the display on the electro-optical display when the driver is looking at the fuel gage.

### DETAILED DESCRIPTION

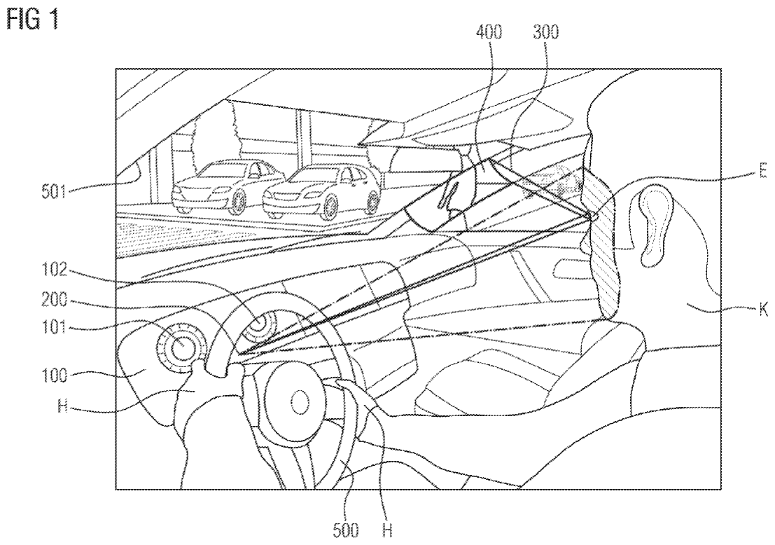

FIG. 1 shows, from a vehicle, an electro-optical display 100 with a

speedometer 101 and a rev counter 102 displayed on the electro-optical display 100, a viewing direction detector 200, an A-pillar 300, a second electro-optical display 400, a steering wheel 500 and a windshield 501. A head K with an eye E and two hands H of a driver of the vehicle may be seen. The viewing direction detector 200 detects the viewing direction and the position of the driver's eyes E and controls the display on the electro-optical display 100 and the second electro-optical display 400 accordingly. The environment of the vehicle is recorded using a device that is not described in any more detail and the section of the environment that is behind the second electro-optical display 400 for the driver is displayed on the electro-optical display 400 so that the driver may virtually see through the A-pillar. This congruent representation is possible through the detection of the eye position and viewing direction by the viewing direction detector 200. In the embodiment shown, the viewing direction detector 200 is arranged in a recess or transparent area of the electro-optical display 200, but may also be arranged at a distance from the electro-optical display 100.

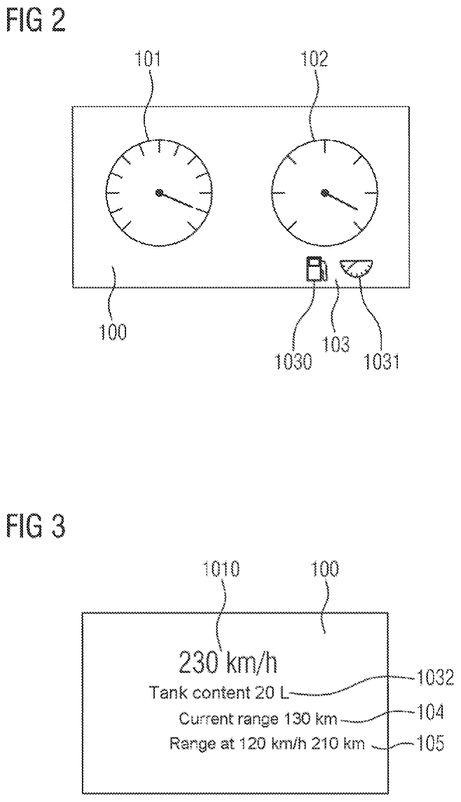

FIG. 2 shows a view of the display on the electro-optical display 100 with a plurality of items of information displayed when the driver is not looking at the electro-optical display 100. A speedometer 101 and a rev counter 102 are shown as analog pointer instruments and a fuel gage 103 with a pictogram 1030 and an analog fuel gage 1031 is shown as an analog pointer instrument. The information presented is not exhaustive and should only be seen as an example. In a real display device with an electro-optical display 100, yet further information such as further operating parameters of the vehicle and/or environmental conditions may be displayed at the same time. If the viewing direction detector 200 now detects that the driver is looking at the fuel gage 103, the display of the electro-optical display 100 is changed as shown in FIG. 3.

A digital speedometer 1010, a digital fuel gage 1032, a digital current range 104 and a digital range at a changed speed 105 may be seen in FIG. 3. The digital speedometer 1010 is displayed because a speed display is required by law to be present at all times. The current range 104 provides information about the distance that may still be covered with the vehicle at the current speed without refueling, the range at 120 km/h 105 provides information about the distance that may be covered with the vehicle at the corresponding speed without refueling. It is also possible to additionally indicate the distance to the nearest gas station and/or to the destination. The representation of the fuel gage in FIG. 3 may be automatically changed back to the display according to FIG. 2 after a certain time or if the driver changes his viewing direction.

1. A display device for a vehicle, comprising:
an electro-optical display; and
a position detection device which is used to determine the position of eyes of a driver of the vehicle,
wherein a multiplicity of different items of information are displayed by of the electro-optical display device and are perceived by the driver of the vehicle, and wherein there is a viewing direction detector for determining the driver's viewing direction, which is used to determine which information the various multiplicity of different items of information is perceived by the driver, and depending on the perceived information, the perceived information is enlarged and/or additional information relating to the perceived information is displayed.

2. The display device as claimed in claim 1, wherein the display of the information is moved and/or changed in size in such a way that no information is hidden from the driver by a component of the vehicle.

3. The display device as claimed in claim 1, it has further comprising a second electro-optical display, wherein additional information is displayed on the second electro-optical display.

4. The display device as claimed in claim 3, wherein the second electro-optical display is arranged on an A-pillar of the vehicle.

5. The display device as claimed in claim 4, wherein the environment behind the A-pillar of the vehicle is displayed on the second electro-optical display.

6. The display device as claimed in claim 1, wherein the viewing direction detector is arranged in an A-pillar, a B-pillar or in a roof liner of the vehicle.

7. The display device as claimed in claim 1, it has further comprising a voice output unit.

8. The display device as claimed in claim 7, wherein a voice message is generated and output when a specific gaze gesture by the driver is detected.

9. A method for displaying information on a display device in a vehicle, wherein the display device has an electro-optical display and a viewing direction detector, comprising:
determining the position of eyes of a driver of the vehicle by the viewing direction detector;
displaying a multiplicity of different items of information by the electro-optical display device so that the multiplicity of different items of information are perceived by the driver of the vehicle;
determining the driver's viewing directions; and
determining which information of the multiplicity of different items of information is perceived by the driver, wherein depending on the perceived information, the perceived information is enlarged and/or additional information relating to the perceived information is displayed.

10. The method as claimed in claim 9, wherein a range of the fuel level for the current driving style is displayed when a fuel gage is displayed.

11. The method as claimed in claim 10, wherein the range of the fuel level for at least one alternative driving style is displayed.

12. The method as claimed in claim 9, wherein the display of the information is moved and/or changed in size in such a way that no information is hidden from the driver by a component of the vehicle.

13. The display device as claimed in claim 1, wherein the display device is connected to a voice output unit.

14. The display device as claimed in claim 13, wherein a voice message is generated and output when a specific gaze gesture by the driver is detected.
